(19) United States
(12) Patent Application Publication
(10) Pub. No.: US 2006/0020926 A1
(43) Pub. Date: Jan. 26, 2006

(54) Detecting and accounting for unknown external interruptions in a computer program environment

(76) Inventors: Stefan R. Bohult, Phoenix, AZ (US); Russell W. Guenthner, Glendale, AZ (US)

Correspondence Address: James H. Phillips - MS B-55;Bull Information Systems Inc., 13430 North Black Canyon Highway, Phoenix, AZ, 85029-1310, US

(21) Appl. No.: 10/899,327

(22) Filed: Jul. 26, 2004

(51) Int. Cl. G06F 9/44

(52) U.S. Cl. 717/134

(57) ABSTRACT

During the emulation of one computer operating system by a physical computer running another operating system, the occurrence of disruptive external events is detected and accounted for. A predetermined estimate of the work which should be necessary to process each emulated “instruction” is entered into a lookup table. As the emulation program runs, the processing of each instruction includes the addition of work units to a running total of work units required to process a given batch of emulated instructions. A real time measure is also kept for the batch and is ordinarily used to update an accumulated total time measure for time accounting purposes except when external events occur which delay processing for some real, but unknown, amount of time. In this case, the real time measure is an inaccurate measure of work done, and the estimated work units is used to update the accumulated total time measure.

### FIELD OF THE INVENTION

This invention relates to the art of computer systems and, more particularly, in the operation of an emulated computer program, to a process for detecting and accounting for processing instruction execution delays due to interruptions by external supervisory programs or hardware interrupts.

### BACKGROUND OF THE INVENTION

In the delivery of computer processing power to customers or end users, it is necessary to provide a controlled level of performance. For example, in the mainframe computing industry, the price charged for a processing unit is often directly related to performance. This practice is common and fully accepted in the computer industry whether a given system is sold to a customer (and must meet or exceed its stated specifications) or a customer is charged for the amount of time the system is effectively employed by that customer.

Customers who have a large, often multi-generational, investment in legacy software for a proprietary operating systems can still use the legacy software even if hardware dedicated to the proprietary operating system is no longer available or is not sufficiently powerful or compact (or for any other reason) if the proprietary operating system is emulated on hardware running another native operating system. For example, the GCOS 8 operating system has been emulated on the Linux operating system.

In the development of code implementing a computer emulation, it has been found that the core emulation code is occasionally interrupted by outside events which delay the processing by the emulation code. These external events stop or interrupt the emulation code for a varying and unpredictable amount of time and usually occur at an unpredictable rate and time. In the emulation code, the accounting of time is based upon a real time clock; thus, outside interruptions cause this accounting to be potentially inaccurate.

Outside interruptions and the processing of unknown external events also have a detrimental effect on performance of the computer emulation code, so detection of these events is important for optimization of performance and development of system design techniques to avoid such interruptions, or assign them to other resources. Further, it will be understood that the system performance must meet stated specifications such that a user will realize the expected value of a given system for the appropriate cost.

In processing computer emulation code, there is repeated processing through a program loop where each pass through the loop results in the emulation of one computer instruction or command. The instructions being processed vary in complexity and in the time required for processing. The expected estimated work required to process each instruction type can be calculated and/or measured and recorded in a table which can be used to predict how long each instruction “should” take to execute as measured in real time.

Direct detection or notification to the computer emulation code of these external interruptions is difficult and not a part of the mechanism that most operating systems provide to a user program. Also, any notification of such events would itself take time away from the user/emulation code.

For these reasons, it is advantageous to provide a mechanism internal to the computer emulation code/program which will detect the occurrence of outside interference without support by the operating system and without any direct notification of such interference.

This detection of external events is also useful for just noticing and proving the occurrence of such events. This detection is important to optimizing the overall system performance.

### OBJECTS OF THE INVENTION

It is therefore a broad object of this invention to provide an emulation system in which external events which would affect time accounting are detected and compensated for.

It is a more particular object of this invention to provide an emulation system in which such compensation is achieved by estimating the time which the execution of a batch of emulated instructions should have taken and selectively using the estimate rather than the real time actually required to execute that batch for time accounting purposes.

### SUMMARY OF THE INVENTION

Briefly, these and other objects of the invention are achieved by estimating the work which should be necessary to process each emulated “instruction” by the emulation code. This “work done” can be defined in any arbitrary unit of measure which can be called a “work unit” where each instruction of some type (an opcode for example) will take some defined number of work units to execute. As the emulation program runs, the processing of each instruction can include the addition of some number of work units, determined by table lookup, to a running total of work units required to process a given batch of emulated instructions. This estimate of work done by using work units is inherently less precise than using the real time clock, except when external events occur as discussed above which delay processing for some real, but unknown, amount of time. In this case, the real time clock is an inaccurate measure of work done, and so the total work units can be used instead of the real time. The determination of when to use work units instead of real time is made whenever a real time clock measure value is examined and compared, after a batch has been processed, to the amount of time estimated to be needed by using work units converted (if necessary) to estimated work done time. If the real time actually taken is much larger than the estimated work done time, then it is assumed that an external interruption or some external event occurred, and the time estimated for work done is used instead of the real time clock measure to update an accumulated total time measure for time usage accounting.

### DESCRIPTION OF THE DRAWING

The subject matter of the invention is particularly pointed out and distinctly claimed in the concluding portion of the specification. The invention, however, both as to organization and method of operation, may best be understood by reference to the following description taken in conjunction with the subjoined claims and the accompanying drawing of which:

FIG. 1 is a high level quasi-block diagram illustrating a basic embodiment of the invention; and

FIG. 2 is a process flowchart illustrating an exemplary implementation of the invention.

### DESCRIPTION OF THE PREFERRED EMBODIMENT(S)

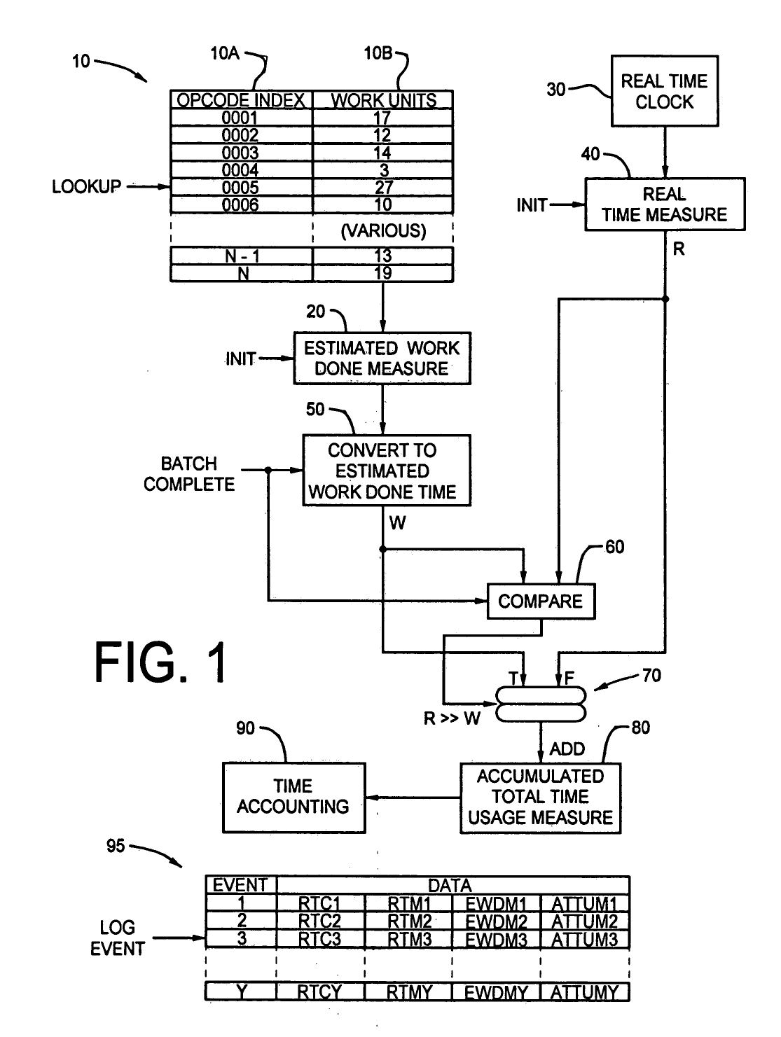

Referring first to FIG. 1, a simplified block diagram shows a system in which one physical computer system emulates another computer system. In this embodiment, only the real time clock 30 of the physical (host) computer system is a hardware component. All the other “components” are implemented/simulated in and operated by the emulation code and/or memory. Thus, a lookup table 10 includes columns 10A and 10B for respectively storing A) individual opcodes for the emulated code (that is, the opcode repertoire of the emulated system), and B) “work units” for each opcode. The “work units” represent the approximate individual temporal effort which should be used by the host system to execute each different opcode of the emulated system. These “work units” can be predetermined by calculation and/or suitable testing while the emulation system is under development. It is preferable to state the “time” in work units because various host systems employing the same operating system may run at different speeds, but execute an emulated instruction in the same number of internal operations. Thus, work units can be converted to actual time for any such host machines as will become more evident below.

In some instances, it may be practical to set the work units to actual estimated work time. It may be particularly appropriate, in some environments, to express the work units in terms of expected processor clock “ticks”, using a tick as the same unit of measure as a CPU clock tick counter which is related to real time by the speed of a physical CPU clock. The term “real time” as used herein includes such use.

In the example of FIG. 1, lookup table 10 stores the instruction repertoire of an emulated system in which the individual instruction opcodes are numbered from 0001 to N in column 10A and in which each opcode entry references a predetermined work unit number in column 10B which reflects the approximate work it should take to execute the emulated instruction identified by that opcode.

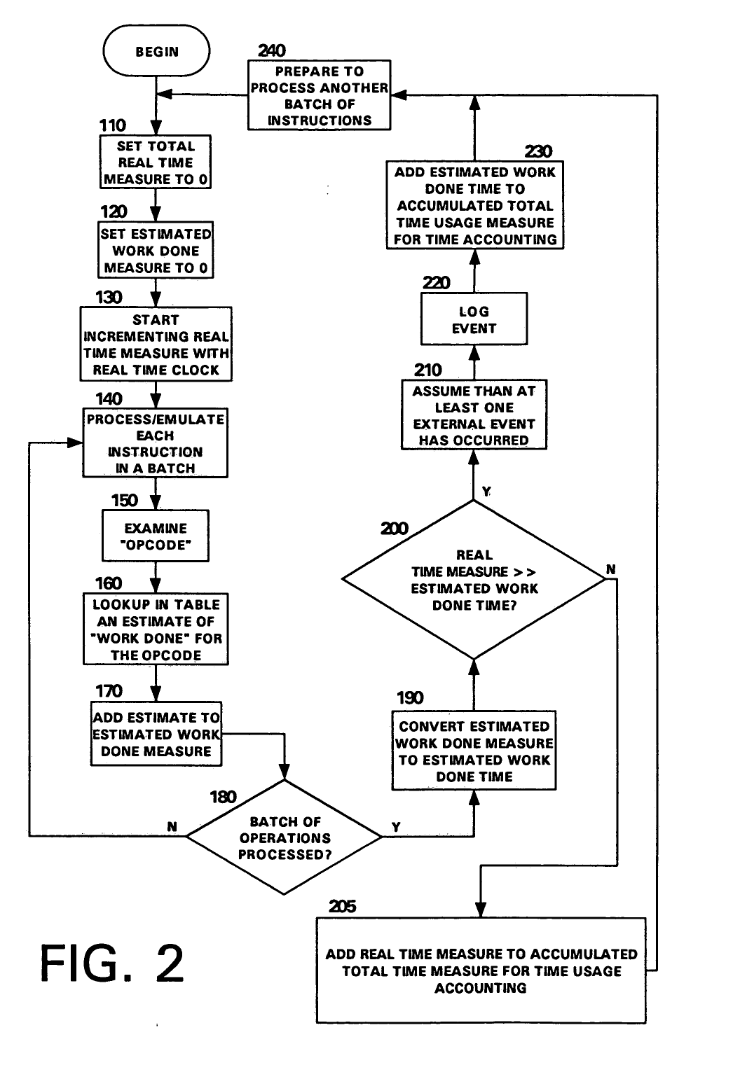

During operation, as will be more particularly described in conjunction with FIG. 2, a batch of emulated instructions are executed after which a check is made to determine if an external event has occurred which results in substantially more time than expected being required for the execution of the batch. The term “batch” is not used herein in any formal manner; the number of instructions in a batch is not critical or even important (and may vary from batch to batch) so long as it is, during normal operation, a suitably large number of emulated instructions so as to prevent the operation of the embodiment of the invention from unduly loading the host system during normal operation. However, of course, a batch can be as small as a single instruction under special circumstances as when trouble shooting to find the source of a recurring outside event.

To start the monitoring of the execution of a given batch of emulated instructions, a real time measure accumulator 40 (count incremented by the real time clock 30) and an estimated work done measure accumulator 20 (contents advanced by work unit information from the lookup table 10 after each instruction is emulated) are zeroed. Thus, both the real time measure 40 and the estimated work done measure 20 accumulate time information as a given batch of instructions is executed.

When a given batch has been processed, the estimated work done measure is converted, block 25, (if necessary) to estimated work done time. Those skilled in the art will understand that this can be achieved by applying a multiplier, appropriate to the performance of the given host system, to the work unit summation then resident in the estimated work done measure 20. The accumulated real time expended in executing all the instructions in the batch is applied from the real time measure 40 to a compare block 50 which also receives the estimated work done time derived from the value of the estimated work unit measure via the convert process 25.

It is expected that the real time (R) expended in processing a batch of emulated instructions will not be substantially longer than the estimated work done time (W) predicted. If that is the case, the output term R>>W from the compare block 50 will be untrue such that AND-gate array 70 is fully enabled through the inverter 75. As a result, the accumulated time recorded in the real time measure 40 will be added to the time already recorded in accumulated total time usage measure block 80. The summation of time then recorded in the accumulated total time usage measure 80 can be used by time accounting 90 as may be desired.

However, if the output term R>>W from compare block 50 is true, indicating that an external event has substantially delayed completion of the emulation of the batch of instructions under consideration, the AND-gate array 60 will be fully enabled such that the estimated work done measure, converted to estimated work done time, is added into the accumulated total time usage measure 80 for accounting purposes.

It may be useful, particularly during development of the emulation system, to log disruptive external events which may occur during the processing of one or a plurality batches. This log can be analyzed off line to help determine the source of any disruptive external events which may have occurred during a test (or operational) run of the emulation system. Log table 95 serves this purpose by recording system conditions at each determination that an external event has occurred. By way of example, the value of the real time clock 30, real time measure 40, estimated work done measure 20 (before or after conversion to estimated work done time or both) and accumulated total time usage measure 80 may be saved for each disruptive external event detected.

Attention is now directed to FIG. 2 which is a detailed process flow chart illustrating an exemplary embodiment of the invention. After the emulation begins, the subject process is initialized at steps 10, 20 and 30. At step 110, the real time measure is set to 0 (or some other predetermined initial value) and, at step 120, the estimated work done measure is set to 0 (or some other predetermined initial value). (These steps could be reversed or simultaneous.) At step 130, the real time measure is enabled to be incremented by the real time clock.

The processing loop, steps 140-180, for a batch of instructions to be emulated is then started. Each instruction in the batch is processed, step 140, then its opcode is used, step 150, to institute lookup in the table (previously discussed in conjunction with FIG. 1) to find the predicted work done in work units, step 160, for adding into the work done measure, step 170. Then, if the batch is not yet completely processed, step 180, the next instruction is processed, return to step 140.

However, if it is found at step 180 that a batch has been fully processed, the accumulated estimated work done measure is converted (if necessary) to estimated work done time at step 190. At step 200, the current value of the real time measure (R) is compared to the estimated work done time (W). If R>>W is untrue (the expected condition) indicating the absence of a disruptive external event having occurred during the processing of the batch under consideration, then the current real time measure value is added, at step 205, to the accumulated total time measure as valid for time usage accounting. Then, processing of another batch is instituted, step 240.

However, if R>>W is true, then the current real time measure is too long and unsuitable for accounting purposes. If such is determined at step 200, it is assumed that an external event has occurred, step 210; and, if provided for, the event is logged at step 220. (This operation could be carried out at any suitable position between steps 200 and 240.)

As previously described, if an external event is detected, the estimated work done time, rather than the real time measure, is added, at step 230, to the accumulated total time usage measure for accounting purposes after which processing of the next batch is instituted, step 240.

The term “R>>W” only need recognize that “R” is significantly higher than “W”. For example, in a Linux computer system emulating the GCOS operating system, a value of R which is about 10% higher than W (R/W=about 1.1) has been found to be suitable when running instruction batches having a few thousand instructions per batch. For smaller batches, an R/W ratio of about 1.5 works well. Thus, for given emulation systems, it is only necessary to take into account these variables to select a suitable value at which R becomes >>than W, and this is not a critical value except that, of course, R/W must be greater than 1.0. If the selected value occasionally returns a substitution when no external event has occurred, the accounting time will still be close to that desired, and experience with a given system may indicate that the selected value be slightly lowered to eliminate such returns.

While the principles of the invention have now been made clear in illustrative embodiments, there will be immediately obvious to those skilled in the art various modifications used in the practice of the invention which are particularly adapted for specific environments and operating requirements without departing from those principles.

What is claimed is:

1. A process for detecting and accounting for interruptions which take place during the emulation of a computer system comprising the steps of:
A) providing a record of expected work units for executing each of a plurality of emulated instructions;
B) initializing a real time measure to a first value;
C) initializing an estimated work done measure to a second value;
D) begin a sample period of the real time measure;
E) serially process a batch of emulated instructions;
F) as each instruction is processed:
1) determine the identification of the emulated instruction being processed;
2) determine from the record provided in step A) the number of work units expected to be required to process the identified emulated instruction;
3) add the number of work units determined in step F)2) to the estimated work done measure; and
4) determine if the processing of the batch of instructions has been completed;
a) if not completed, return to step E);
b) if completed, go to step G);
G) convert the value of estimated work done measure since step C) to estimated work done time (W);
H) determine if the value (R) of the real time measure since step B) is >>than W;
1) if R is not >>W, go to step I):
2) if R>>W, go to step J);
I) add R to an accumulated total time usage measure for time usage accounting and go to step K);
J) add W to the accumulated total time usage measure for time usage accounting; and
K) prepare to process another batch of instructions and go to step B).

2. The process of claim 1 in which, if R>>W in step H), an identification of the batch just processed is logged with the values of R and W which were just compared.

3. The process in claim 1 in which R>>W becomes true when the ratio of R/W is at least about 1.1.

4. The process in claim 1 in which R>>W becomes true when the ratio of R/W is at least about 1.5.

5. A process for detecting and accounting for interruptions which take place during the emulation of a computer system comprising the steps of:
A) providing a record of expected work times for executing each of a plurality of emulated instructions;
B) initializing a real time measure to a first value;
C) initializing an estimated work time measure to a second value;
D) begin a sample period of the real time measure;
E) serially process a batch of emulated instructions;
F) as each instruction is processed:
1) determine the identification of the emulated instruction being processed;
2) determine from the record provided in step A) the work time expected to be required to process the identified emulated instruction;
3) add the work time determined in step F)2) to the estimated work done time measure; and
4) determine if the processing of the batch of instructions has been completed;
a) if not completed, return to step E);
b) if completed, go to step G);
G) determine if the change in (R) value of the real time measure since step B) is >>than the change in value (W) of the estimated work done time since step C);
1) if R is not >>W, go to step H):
2) if R>>W, go to step I);
H) add R to an accumulated total time usage measure for time usage accounting and go to step J);
I) add W to the accumulated total time usage measure for time usage accounting; and
J) prepare to process another batch of instructions and go to step B).

6. The process of claim 5 in which, if R>>W in step H), an identification of the batch just processed is logged with the values of R and W which were just compared.

7. The process in claim 5 in which R>>W becomes true when the ratio of R/W is at least about 1.1.

8. The process in claim 5 in which R>>W becomes true when the ratio of R/W is at least about 1.5.

9. A process for detecting and accounting for interruptions which take place during the processing of work by a computer system comprising the steps of:
A) providing a record of expected work units for executing each of a plurality of tasks;
B) initializing a real time measure to a first value;
C) initializing an estimated work done measure to a second value;
D) begin a sample period of the real time measure;
E) serially process a batch of tasks;
F) as each task is processed:
1) determine the identification of the task being processed;
2) determine from the record provided in step A) the number of work units expected to be required to process the identified task;
3) add the number of work units determined in step F)2) to the estimated work done measure; and
4) determine if the processing of the batch of tasks has been completed;
a) if not completed, return to step E);
b) if completed, go to step G);
G) convert the value of estimated work done measure since step C) to estimated work done time (W);
H) determine if the value of the real time measure (R) since step B) is >>than W;
1) if R is not >>W, go to step I):
2) if R>>W, go to step J);
I) add R to an accumulated total time usage measure for time usage accounting and go to step K);
J) add W to the accumulated total time usage measure for time usage accounting; and
K) prepare to process another batch of tasks and go to step B).

10. The process of claim 9 in which, if R>>W in step H), an identification of the batch just processed is logged with the values of R and W which were just compared.

11. The process in claim 9 in which R>>W becomes true when the ratio of R/W is at least about 1.1.

12. The process in claim 9 in which R>>W becomes true when the ratio of R/W is about 1.5.
